(19) United States
(12) Patent Application Publication
(10) Pub. No.: US 2013/0160058 A1
(43) Pub. Date: Jun. 20, 2013

(54) Video EPOCH Coordination And Modification

(71) Applicants: Nandakishore A. Albal, Scottsdale, AZ (US); John M. Harris, Glenview, IL (US)

(72) Inventors: Nandakishore A. Albal, Scottsdale, AZ (US); John M. Harris, Glenview, IL (US)

(73) Assignee: Nokia Siemens Networks Oy

(21) Appl. No.: 13/329,512

(22) Filed: Dec. 19, 2011

(51) Int. Cl. H04W 28/08; H04N 7/16; H04L 12/26

(52) U.S. Cl. 725/62; 370/235

(57) ABSTRACT

A method is disclosed that includes detecting a temporal loading imbalance in system loading. The imbalance occurs at least at a wireless infrastructure network element in a wireless network. In response to the detecting, one or both of the following are performed: a message is transmitted to a service entity indicating the temporal loading imbalance, the service entity serving one or more video streams to one or more user equipment connected to the wireless network; or one or more modifications are made associated with at least one of the one or more video streams by determining in a current epoch the one or more modifications to apply in one or more upcoming epochs for the at least one video stream, and, in response to the one or more upcoming epochs becoming current epochs, the one or more modifications are applied. Apparatus and program products are also disclosed.

### TECHNICAL FIELD

This invention relates generally to networks and, more specifically, relates to the delivery of video to a user equipment (UE) in wireless communication with a radio access network.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The following abbreviations that may be found in the specification and/or the drawing figures are defined as follows:
ALS Apple live stream
AWT alternate wireless technology
BTS base transceiver station
CAN-EG content aware network-enabling gateway
CDN content delivery network
CN core network
DL downlink (from base station to user equipment)
DPI deep packet inspection
eNode B (eNB) evolved Node B (LTE base station)
E-UTRAN evolved UTRAN
GGSN gateway GPRS support node
GOP group of pictures
GPRS general packet radio service
GPS global positioning system
GTP GPRS tunneling protocol
HLR home location register
HO handover
HSS home subscriber server
HTTP hypertext transfer protocol
LTE long term evolution
Node B (NB) Node B (base station in UTRAN)
MME mobility management entity
MSS Microsoft smooth stream
MO media optimizer
NBG NSN browsing gateway
NSN Nokia Siemens Networks
PCRF policy control and charging rules function
PDN-GW packet data network-gateway
RAN radio access network
RNC radio network controller
SGSN serving GPRS support node
UE user equipment
UL uplink (from UE to base station)
UMTS universal mobile telecommunications system
UTRAN universal terrestrial radio access network

More wireless, mobile devices are able to download or stream video, and this trend appears to be increasing. In fact, some estimates expect video to be over 66 percent of the data traffic in the near future. A radio access network (RAN) serving many mobile devices ideally would be able to handle all of the video being requested by these devices. However, as the number of mobile devices increases and video remains popular, RANs may not be able to deliver all of the requested video as efficiently as possible.

A service entity such as media optimizer (MO) and video servers use corresponding video protocols used to optimize video downloading provide powerful techniques for significantly increasing system capacity and video quality. Currently MOs and self-optimizing video protocols like Apple Live Stream (ALS) and Microsoft Smooth Stream (MSS) function on an epoch basis, i.e., media adjustment every “x” seconds and either send only an “x” second portion of video or a steady stream of video with modifications every “x” seconds. For instance, an epoch for ALS is 10 seconds, a typical MO has an epoch of three or five seconds, and an epoch for MSS is two seconds.

There are certain problems that occur with epoch usage, such as when these epochs align in the RAN leading to a demand for a large bandwidth, and it would be beneficial to correct these problems.

### SUMMARY

In an exemplary embodiment, a method is disclosed that includes detecting a temporal loading imbalance in system loading, the imbalance occurring at least at a wireless infrastructure network element in a wireless network; in response to the detecting, performing one or both of the following: transmitting a message to a service entity indicating the temporal loading imbalance, the service entity serving one or more video streams to one or more user equipment connected to the wireless network; or making one or more modifications associated with at least one of the one or more video streams by determining in a current epoch the one or more modifications to apply in one or more upcoming epochs for the at least one video stream, and, in response to the one or more upcoming epochs becoming current epochs, applying the one or more modifications.

In another exemplary embodiment, an apparatus includes one or more processors and one or more memories including computer program code. The one or more memories and the computer program code are configured to, with the one or more processors, cause the apparatus to perform at least the following: detecting a temporal loading imbalance in system loading, the imbalance occurring at least at a wireless infrastructure network element in a wireless network; in response to the detecting, performing one or both of the following: transmitting a message to a service entity indicating the temporal loading imbalance, the service entity serving one or more video streams to one or more user equipment connected to the wireless network; or making one or more modifications associated with at least one of the one or more video streams by determining in a current epoch the one or more modifications to apply in one or more upcoming epochs for the at least one video stream, and, in response to the one or more upcoming epochs becoming current epochs, applying the one or more modifications.

An additional exemplary embodiment discloses a computer program product comprising a computer-readable medium bearing computer program code embodied therein for use with a computer, the computer program code comprising: code for detecting a temporal loading imbalance in system loading, the imbalance occurring at least at a wireless infrastructure network element in a wireless network; code, in response to the detecting, for performing one or both of the following: transmitting a message to a service entity indicating the temporal loading imbalance, the service entity serving one or more video streams to one or more user equipment connected to the wireless network; or making one or more modifications associated with at least one of the one or more video streams by determining in a current epoch the one or more modifications to apply in one or more upcoming epochs for the at least one video stream, and, in response to the one or more upcoming epochs becoming current epochs, applying the one or more modifications.

A further exemplary embodiment includes an apparatus including means for detecting a temporal loading imbalance in system loading, the imbalance occurring at least at a wireless infrastructure network element in a wireless network; means, responsive to the detecting, for performing one or both of the following: transmitting a message to a service entity indicating the temporal loading imbalance, the service entity serving one or more video streams to one or more user equipment connected to the wireless network; or making one or more modifications associated with at least one of the one or more video streams by determining in a current epoch the one or more modifications to apply in one or more upcoming epochs for the at least one video stream, and, in response to the one or more upcoming epochs becoming current epochs, applying the one or more modifications.

### BRIEF DESCRIPTION OF THE DRAWINGS

In the attached Drawing Figures:

FIG. 1 illustrates a block diagram of an exemplary system in which the instant invention may be used.

FIG. 2 illustrates a block diagram of another exemplary system in which the instant invention may be used.

FIG. 3 illustrates a block diagram of an exemplary computer system suitable for implementing embodiments of the instant invention.

FIG. 4 illustrates mismatch between compression and link speed when a MO/server is oblivious to epoch overlap/periodicity/offset.

FIG. 5 illustrates mismatch between compression and link speed when more variable RF conditions/higher mobility are occurring.

FIG. 6 illustrates an example of aperiodic temporal loading imbalance.

FIG. 7, including portions 7A through 7D, is a flowchart of an exemplary method for video epoch coordination and modification.

### DETAILED DESCRIPTION OF THE DRAWINGS

There are certain problems with epochs. These problems will be described in more detail, once an overview of systems into which the invention may be used is described.

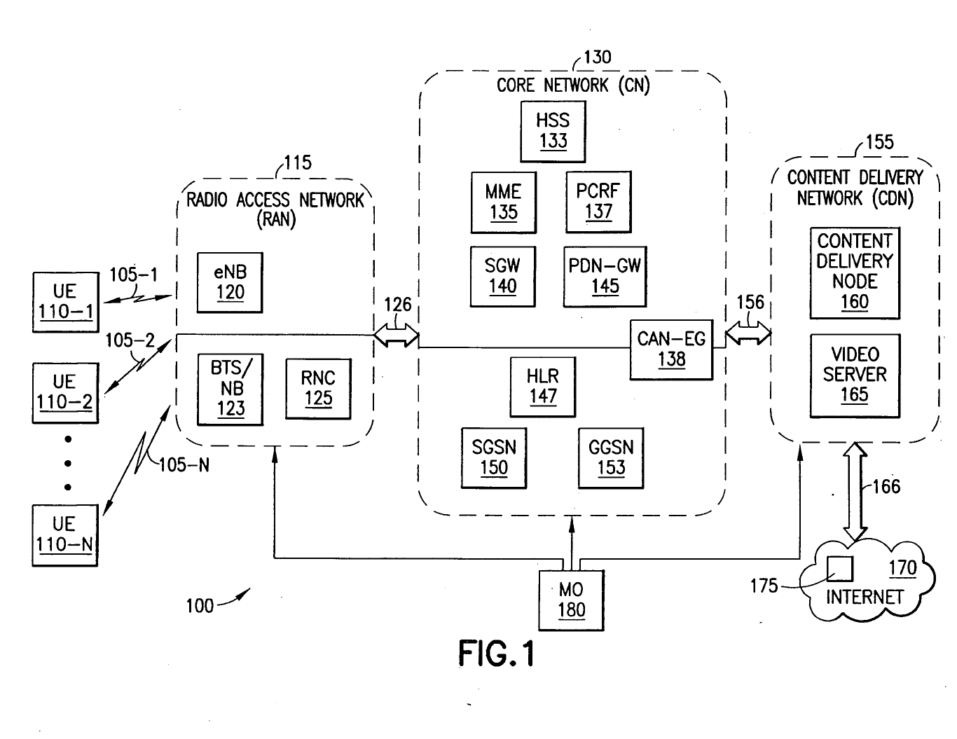

Turning now to FIG. 1, this figure illustrates a block diagram of an exemplary system into which the instant invention may be used. FIG. 1 is an example of a video server—RAN interfaced architecture for, e.g., a macro cell. The architecture shows N user equipment 110-1 through 110-N communicating via a corresponding wireless connection 105-1 through 105-N (including uplink and downlink) to a network 100. The network 100 includes a RAN 115, a core network (CN) 130, and a content delivery network (CDN) 155. The CDN 155 is connected to the Internet 170 via one or more links 166. The RAN 115 is connected to the CN 130 via one or more links 126. The CN 130 is connected to the CDN 155 via one or more links 156.

In an E-UTRAN embodiment, the RAN 115 includes an eNB (evolved Node B, also called E-UTRAN Node B) 120, and the CN 130 includes a home subscriber server (HSS) 133, a serving gateway (SGW) 140, a mobility management entity (MME) 135, a policy and charging rules function (PCRF) 137, and a packet data network gateway (PDN-GW) 145. E-UTRAN is also called long term evolution (LTE). The one or more links 126 may implement an S1 interface.

In a UTRAN embodiment, the RAN 115 includes a base transfer station (BTS) (Node B) 123, and a radio network controller 125, and the CN 130 includes a serving GPRS support node (SGSN) 150, a home location register (HLR) 147), and a gateway GPRS support node (GGSN) 153. The one or more links 126 may implement an Iu interface.

The CAN-EG 138 may be part of either EUTRAN or UTRAN and is a network entity that enables the alignment of the network resources (such as bandwidth required, Quality of Service, type of bearer (best-effort, guaranteed, non-guaranteed, dedicated)), with the needs of the service and alignment of these resources through the session.

The CDN 155 includes a content delivery node 160 and a video server 165, which may also be combined into one single node. The content delivery node 160 may provide a cache of information on the Internet 170. The video server 165 may provide a cache of video, e.g., at different compression rates and/or resolutions.

The examples above indicate some possible elements within the RAN 115, CN 130, and CDN 155 but are not exhaustive, nor are the shown elements necessary for the particular embodiments. Furthermore, the instant invention may be used in other systems, such as CDMA (code division multiple access) and LTE-A (LTE-advanced).

In this example, one or more of the user equipment 110 connects to the content source 175 in the Internet 170 to download video via, e.g., a service entity such as a media optimizer (MO) 180, CDN 160 or video server 165. The video server 165 in this example is a cache video server, meaning that the video server 165 has a cached copy of video stored on the content source 175. The content source 175 may be an origin server, which means the content source 175 is the original video source (e.g., as opposed to a video server 165 having cached content). The MO 180 may be implemented in the RAN 115, the CN 130, and/or the CDN 155. Optimized content is streamed from the MO 180 or video server 165 to the PDN-GW 145/GGSN 153, which forwards the content to the SGW 140/SGSN 150 and finally through the eNodeB 120/NB 123 to the UE 110. If the video server(s) 165 are used, the servers are considered surrogate servers, since these servers 165 contain cached copies of the videos in content sources 175.

The video contained in one or more video streams between elements in the wireless network 100 is carried over the wireless network 100 using hypertext markup language (HTML). The videos are requested by user equipment 110 through a series of separate uniform resource locators (URLs), each URL corresponding to a different video stream of the one or more video streams.

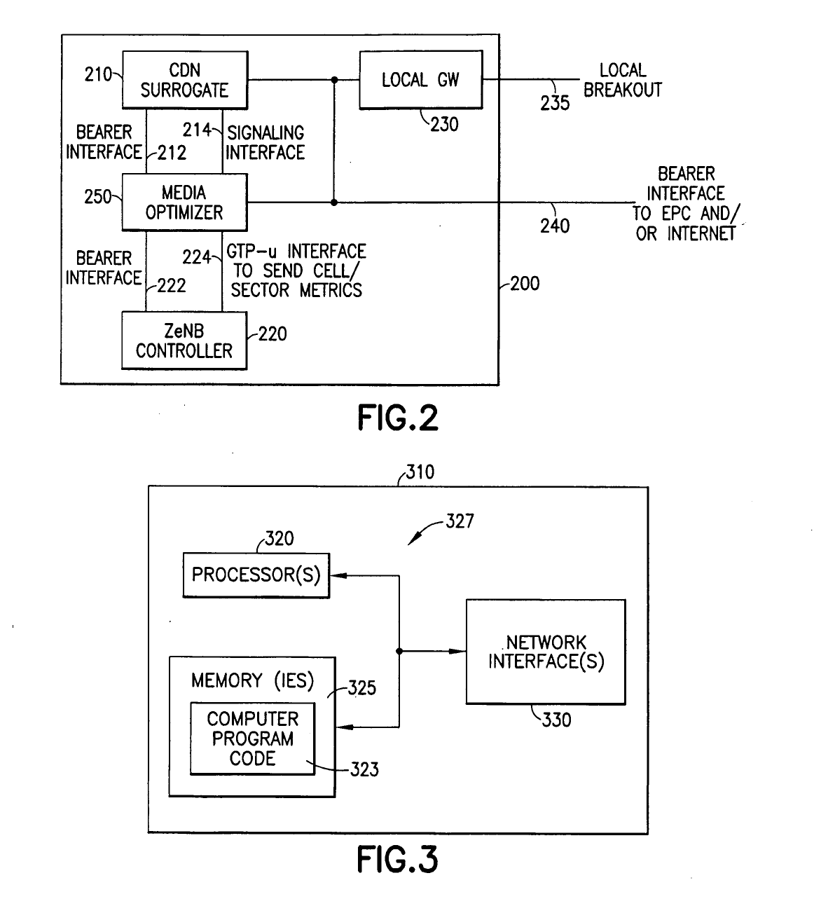

Referring to FIG. 2, this figure illustrates a block diagram of another exemplary system in which the instant invention may be used. This is an example of applicability to “small” cell architectures, such as pico or femto cells. In this example, the system 200 is located near or coincident with a cell phone tower. The system 200 includes a “zone” eNB (ZeNB) controller 220, a media optimizer 250, a content delivery network (CDN) surrogate 210, and a local gateway (GW) 230. The ZeNB controller 220 controls multiple eNodeBs (not shown in FIG. 2) and communicates with the media optimizer 250 using, in this example, a bearer interface 222 and a GTP-u interface 224. The GTP-u interface 224 allows the ZeNB controller 220 to send cell/sector metrics to the media optimizer 250 and allows the ZeNB controller 220 to receive requests from the media optimizer 250. Such metrics provide the media optimizer 250 an indication of the state of the cell/sector that the media optimizer 250 uses to determine the parameters for video optimization.

The media optimizer 250 communicates in this example with a CDN surrogate 210 via a bearer interface 212 and a signaling interface 214. The CDN surrogate 210 acts as a local cache of content such as video. The CDN surrogate 210 communicates with a bearer interface 240 (as does the media optimizer 250) to the evolved packet core (EPC), the Internet, or both. The local gateway 230 also communicates via a network 235 providing a local breakout of bearer traffic to the network instead of routing the bearer traffic over the wireless network via interface 240.

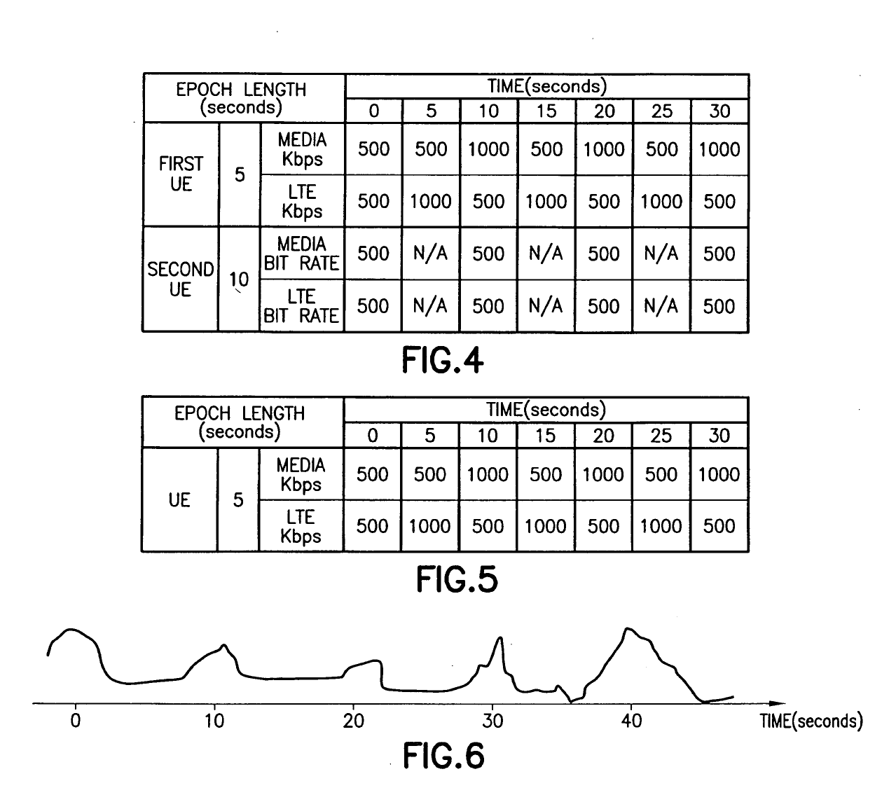

Turning now to FIG. 3, this figure illustrates a block diagram of an exemplary computer system suitable for implementing embodiments of the instant invention. As described above and in more detail below in reference to signaling diagrams, the exemplary embodiments involve multiple entities in the network 100, such as the media optimizer 150, the PDN-GW 135, the eNodeB 120, the CDN surrogate 210, the video servers 160, the content sources 160, and/or the CAN-EG 145. Each one of these entities may include the computer system 310 shown in FIG. 3. Computer system 310 comprises one or more processors 320, one or more memories 325, and one or more network interfaces 330 connected via one or more buses 327. The one or more memories 325 include computer program code 323. The one or more memories 325 and the computer program code 323 are configured to, with the one or more processors 320, cause the computer system 310 (and thereby a corresponding one of, e.g., the media optimizer 150, the PDN-GW 135, the eNodeB 120, the CDN surrogate 210, the video servers 160, the content sources 160, and/or the CAN-EG 145) to perform one or more of the operations described herein.

Now that an exemplary system has been described, the problems concerning epochs are described in more detail. As stated above, an epoch for ALS is 10 seconds, a typical MO has an epoch of three or five seconds, and an epoch for MSS is two seconds. In a typical case, therefore, the compression rate and video resolution is kept constant during a particular epoch. That is, a decision is made, potentially based on RF conditions or other network conditions (e.g., in the CN 130) as to what the compression rate should be for a video. This decision currently occurs at the beginning of an epoch and the selected compression rate is assigned to the current epoch.

In the typical case where more than one video user is in the same cell (called video unicast), the epochs between the users can overlap or not overlap. Currently, the staggering of these epochs is random, based on the session start. It is advantageous to have the video epoch boundaries of users in a cell staggered in a non-random way, to normalize the distribution of DL data in the RAN across all users irrespective of the video protocol and their epochs. This reduces the amount of variability of the total sector loading. This also reduces the variability of the bit rate encountered by the video application/adaptation protocol from epoch to epoch. However, as explained in more detail below, this epoch alignment awareness can be further incorporated into an algorithm that anticipates the appropriate level compression for the next epoch. Staggering in a non-random way the video epoch boundaries of users in a cell also reduces the eNB memory-limitation-caused packet loss. Additionally, this avoids the very real problem of over compressing just after epochs happened to align and of under compressing just after epochs were relatively nonaligned/sparse.

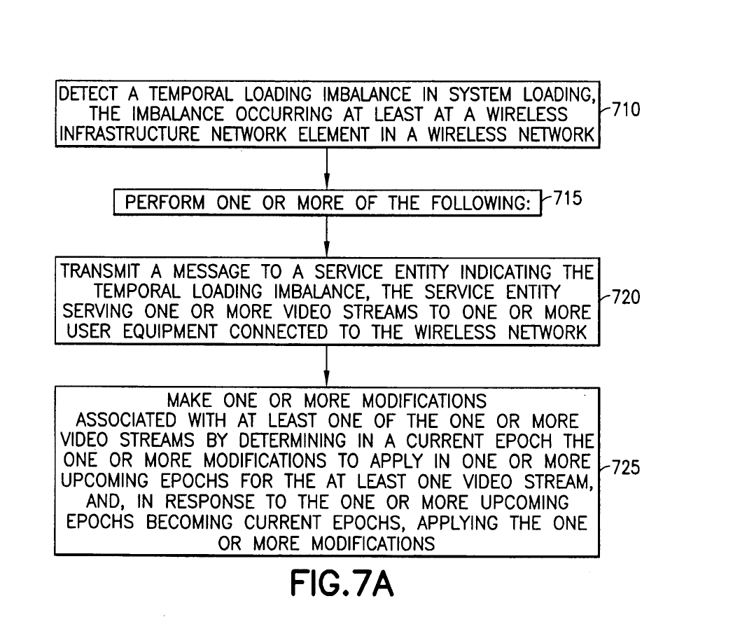

In FIG. 4, the first UE is being provided video from a MO 180 having an epoch length of 5 seconds, and the second UE is being provided from an ALS server 165 (or 175) having an epoch length of 10 seconds. At time zero, a corresponding network entity (e.g., MO 180 in the case of the first UE, or an application server, or a CAN-EG) detects that there is a periodic mismatch between the link speed estimate and the actual link speed. The network entity then determines a corresponding media speed, which is 500 kbps in the first two epochs. Decisions are made on epoch boundaries.

Even though a UE downloads video with a media rate of 500 kbps, the UE may actually achieve actual bit rates higher than this. For instance, if the second UE is downloading a video encoded at 500 kbps, during a 10 second epoch, all of the 10 seconds of data may be downloaded in a few seconds or less, since the LTE DL rate can be, e.g. 30 mbps (mbps) for a single UE. Therefore, a 10 second epoch worth of video at 500 kbps can be downloaded in as little time as (10 s*500 kbps)/30,000 kbps, or in tens of milliseconds. However, actual rates will likely vary from this theoretical data rate. Nonetheless, a UE can still fit within an assigned 500 kbps LTE bit rate and download video within a fraction of an epoch.

In the example of FIG. 4, the second UE has downloaded video such that at the epoch boundary for the first UE at five seconds, the second UE is not downloading video. In fact, the second UE may not download video during the five second epoch from five to 10 seconds. The effective possible LTE bit rate during this epoch is therefore 1000 kbps. The first UE (or a network entity) therefore assumes at the beginning of the epoch boundary that occurs at 10 seconds that the media kbps to be requested for this epoch (from 10 seconds to 15 seconds) may be 1000 kbps, and the UE/network entity requests this media kbps rate during the epoch from 10-15 seconds. This shows that two epochs that align cause the first UE/network entity to consequently want to use more compression during every other epoch (e.g., the epochs from 5-10 seconds; 15-20 seconds; and 25-30 seconds). Additionally, the UE/network entity requests too much video (or not enough compression) for the first UE during every remaining every other epoch (e.g., the epochs from 10-15 seconds; 20-25 seconds; and 30-35 seconds).

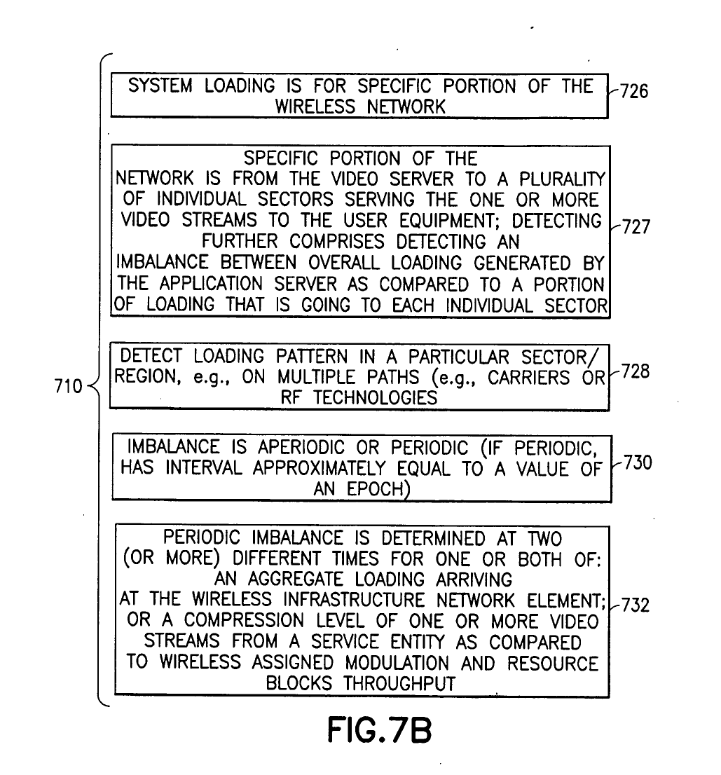

Turning now to FIG. 5, FIG. 5 illustrates mismatch between compression and link speed when more variable RF conditions/higher mobility are occurring. In this case, the LTE kbps is varying between 500 and 1000 kbps. In this case, the LTE kbps rate in the 5-10 second epoch is 1000 kbps, but the UE or a network entity bases the current epoch media rate (and therefore the level of video compression) for the 5-10 second epoch on the L rate that occurred in the 0-5 second epoch. Similarly, the UE/network entity bases the media rate for the 10-15 second epoch based on the LTE rate in the 5-10 second epoch. Thus, the UE/network entity wants to use more compression during every one out of every five epochs (e.g., the epochs from 5-10 seconds; 15-20 seconds; and 25-30 seconds and not enough compression during every one out of every five epochs (e.g., the epochs from 10-15 seconds; 20-25 seconds; and 30-35 seconds).

Alternatively, FIG. 5 can be considered to provide an example of aligned epochs. This figure shows an example of a mismatch between compression and link speed when a MO/server is oblivious to epoch overlap/periodicity/offset.

The exemplary embodiments herein improve these situations. Before proceeding with descriptions of the exemplary embodiments, it is noted that a video epoch may be determined by one or more of the following: a direct bearer usage pattern observation without deep packet inspection (DPI); a deep packet inspection at the RAN; a deep packet inspection at the server, or on the network 100; communication from the MO/server to the RAN; a tightly coupled architecture where the MO, RAN can be coupled (e.g., AWT).

In an exemplary embodiment, an automated mechanism is disclosed for reducing differences between compression level and wireless link speed based on epochs. For instance, a MO/server/video client may modify at least one of an offset at which a future epoch occurs or a duration of a future epoch. The MO/server/video client may also modify a compression level to be used in the next epoch to a different compression level from a compression level used in a current epoch.

These modifications may be based on a relative number of overlapping epochs during different time intervals. For instance, the modifications may be based on a relative number of overlapping epochs during the previous epoch and anticipated in the next epoch, or at a midpoint between the current and the next epoch. A MO/server determines the relative offset and/or durations of MO/video server (ALS/MSS) epochs. The modifications may be based on the same geographic proximity (e.g., this can be performed strictly at the application layer). The modifications may be based on the same sector (can be performed at the application layer or based on explicit coupling with RAN), same back-haul, same controller, and/or adjacent sectors (e.g., enabling inter-cell interference coordination).

These modifications may also be based on historical amount of variability in the wireless link speed observed (e.g., bit rate observed), and this may include mobility. In this case, mobility may be based on, as examples, the handoff history, the GPS history, and/or the anticipated UE route or trajectory. This may also include the case where other video users are not served by this video server/MO and therefore this video server/MO has no direct visibility to the alignment or offset of epochs for other video streams which are routed through other video servers or other media optimizers.

As described above, some examples include shifting a future epoch (e.g., by delaying a normal start of the epoch by an offset) and/or changing compression level based on overlaps/alignment of epochs. These may be performed straightforwardly in the media optimizer or in an MSS server. In ALS, one may change the amount of initial delay at the start of video, or require communication down (from the RAN to the UE) to an ALS client in the UE, or up (from the RAN to a video server via the CAN-EG) to an enhanced ALS protocol. This could involve slightly slower or faster play out of the video. This can also involve re-partitioning sections of media so that the file for a particular epoch now contains a longer segment of media. It is also possible to handover an LTE UE to an alternate carrier or RF technology to avoid epoch alignment where the periodic loading on the alternate carrier or RF technology is out of phase with the periodic loading on this carrier or RF technology.

Shifting an epoch or changing compression level may be achieved through an indication from the RAN (e.g., an entity in the RAN) and/or location server to the MO/application ALS/MSS, e.g., in a GTP-c control message. This indication could indicate a sector or location of the UE. The indication may request particular staggering offsets. The indication from the RAN may include indication(s) of a loading “pattern” indicating the periodic structure of the loading at the RAN, e.g. indicating that the loading is consistently going up every Y seconds, and then declining relative to a specific timing offset or anchor. The loading pattern is determined by the RAN based on monitoring overall traffic loading that is arriving at the RAN. The shifting or compression level determination may be made on the pattern.

Shifting an epoch or changing compression level may also be achieved by a MO or application determination of UE location at the application level, e.g. through sector number, cell number, or GPS reported through the application within the UE, up to the application server or to the media optimizer, or through the location server or the MME. This may also be achieved by having the MO query the RAN for the loading “pattern” or for a better offset.

Changing the epoch duration, e.g., based on variability, can easily be implemented in all protocols, including in the client (e.g., ALS or MSS or other client).

A number of additional exemplary embodiments are now presented.

1) In one example, a server/NBG/CAN-EG/MO detects a problem and changes offset of a video epoch for a video stream for one or more UEs. For instance, a server/NBG/CAN-EG/MO detects the loading pattern in a particular sector/region, such as by receiving messaging from the RAN based on the RAN's observation of the periodic structure, or by using direct knowledge of the epoch length and offset of the users passing through its server (i.e., the server streaming the video), NBG (e.g., a video server and MO in one “box”), and/or CAN-EG. It is noted that the server/NBG/CAN-EG/MO are network entities through which video streams pass (including originate).

The detection of the problem may also include a determination of a periodic loading imbalance between compression level and wireless link speed, including an identification that at least one user has video traffic that is aligned with an interval having a higher periodic loading imbalance (relative to other intervals). The server/NBG/CAN-EG/MO may also transmit a request for that specific user changing the offset to align the epoch with an interval of lower periodic loading imbalance.

2) In another example, a RAN requests one or more changes in epoch offset. These requests may be the result of the RAN detecting a loading pattern in a particular sector/region, or determining periodic loading imbalance. The RAN may also identify (at least one) specific user that has video traffic that is aligned with an interval having higher periodic loading imbalance relative to other intervals. In one example, the RAN transmits a request to, e.g., the CAN-EG for that specific user, requesting a change in the offset of a corresponding epoch to align the epoch with an interval of lower periodic loading imbalance.

3) In another example, a RAN requests a handoff/technology change. For instance, a RAN could detect loading pattern in a particular sector/region, on multiple paths (e.g., carriers or RF technologies). The RAN could determine a periodic loading imbalance on a first path and a second path. The RAN identifies a (an at least one) user whose traffic is aligned with an interval of higher periodic loading imbalance on the first path but an interval of lower periodic loading imbalance on the second path. The RAN transmits messaging including, e.g., a handoff command/measurement report to handoff that user to a different RF technology with a different periodic loading imbalance.

4) In a further exemplary embodiment, a RAN requests one or more changes in epoch duration. The RAN detects variable loading patterns or upcoming handoff or upcoming loading change (e.g., with a new service just admitted). The RAN may identify a user with a longer epoch, and may transmit a request to, e.g., the CAN-EG for that specific user to cause the epoch duration to be changed to a shorter duration from a current duration. Conversely, the RAN may request a longer epoch duration in an opposite case. Alternatively, if because of inter-cell interference coordination, it is actually advantageous to align the epochs across users, then that may also be requested by the RAN and implemented by, e.g., the CAN-EG.

5) In yet another exemplary embodiment, a video client subscribes to information on video loading pattern for the sector of the video client, and the video client receives this information from the server, or possibly other sources. The video client determines periodic loading imbalance and identifies at least one user (not using the video client) having video traffic that is aligned with an interval of higher periodic loading imbalance. The video client may initiate changing the offset to align the epoch with an interval of lower periodic loading imbalance.

6) In a further exemplary embodiment, it is possible to change epoch length or offset. For instance, in the case of the media optimizer, this is straightforwardly able to be optimized, as the epoch is entirely constructed by the media optimizer itself. From the perspective of the server, there is one large download of video. In the case of MSS, the protocol is sufficiently flexible that epoch start times can be set fairly arbitrarily. In the case of ALS (which is currently much less prevalent than MSS), this can be achieved by, e.g., adjusting the delay before the initial video play out begins. This can also be achieved through the ALS protocol itself, similar to MSS. For instance, the default epochs for ALS and MSS are 10 seconds and two seconds (respectively), but the protocols have some flexibility that allows changing from these default values.

It is noted that the video content itself can of course be delayed within the radio access network, using the client's buffer to absorb the additional delay within the network. However, this causes the UE video play out to become incrementally more likely to exhaust the buffer within the UE. Consequently, principally the focus herein is on the case where the pattern (e.g., of network loading) is explicitly shifted at the application layer.

In another exemplary embodiment, the RAN detects an imbalance in the loading pattern and shifts the transmission of the video to stagger the epochs, therefore smoothing the imbalance. If one changes a duration for a single epoch (with all other epochs having the original duration), then this effectively changes the epoch offset. If one reduces the duration permanently, this can permanently make the protocol more reactive to changes in wireless link speed. Additionally, changing the duration can enable two different users to have the same epoch duration, simplifying the alignment of the loading generated by the two different users. Alternatively, shifting of an epoch can be achieved by having a client request the next section of video slightly earlier or later relative to the client's need for play out. In yet another embodiment, the client can play out a particular epoch more or less slowly and thereby shift the time when each subsequent epoch is requested. Shifting an epoch or changing compression level may be achieved through an indication from the RAN (e.g., an entity in the RAN) and/or location server to the MO/application ALS/MSS, e.g., in a GTP-c control message. The indication may request particular staggering offsets. Shifting an epoch or changing compression level may also be achieved by a MO or application. This may also be achieved by having the MO query the RAN for the loading “pattern” or for a better offset. Changing the epoch duration, can easily be implemented in all protocols, including in the MSS client.

The exemplary embodiments have the following exemplary and non-limiting advantages. The exemplary embodiments enable smoothing video loading among users within a sector. This minimizes bursty communications resulting from the epoch structure created by video, e.g., passing through a media optimizer. This also facilitates more even distribution of video traffic, which is expected to be over 66 percent of all data traffic over the air, thereby optimizing RF resource allocation. Similarly, eNB memory-limitation-caused packet loss is reduced. Additionally, this avoids the very real problem of over compressing just after epochs happened to align or under compressing just after epochs were relatively nonaligned/sparse.

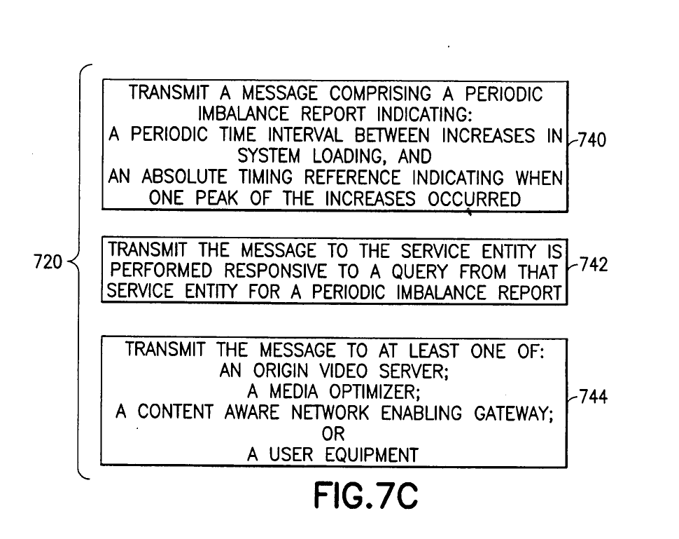

Primary emphasis above is placed on periodic temporal loading imbalances, such as an imbalance between compression level and wireless link speed. However, the instant invention is not limited thereto. For instance, referring now to FIG. 6, this figure illustrates an example of aperiodic temporal loading imbalance. FIG. 6 shows an example where the traffic generally increases approximately every 10 seconds, but does not have a strictly periodic structure. This might be captured by looking at the local maximum amount of loading (e.g. what is the maximum loading in any given five second interval?), and then identifying that these local maxima appear every 10 seconds, plus or minus two seconds over the last threshold number of 10 second intervals. In FIG. 6, one can see that the traffic peaked every 10 seconds relative to the adjacent loading.

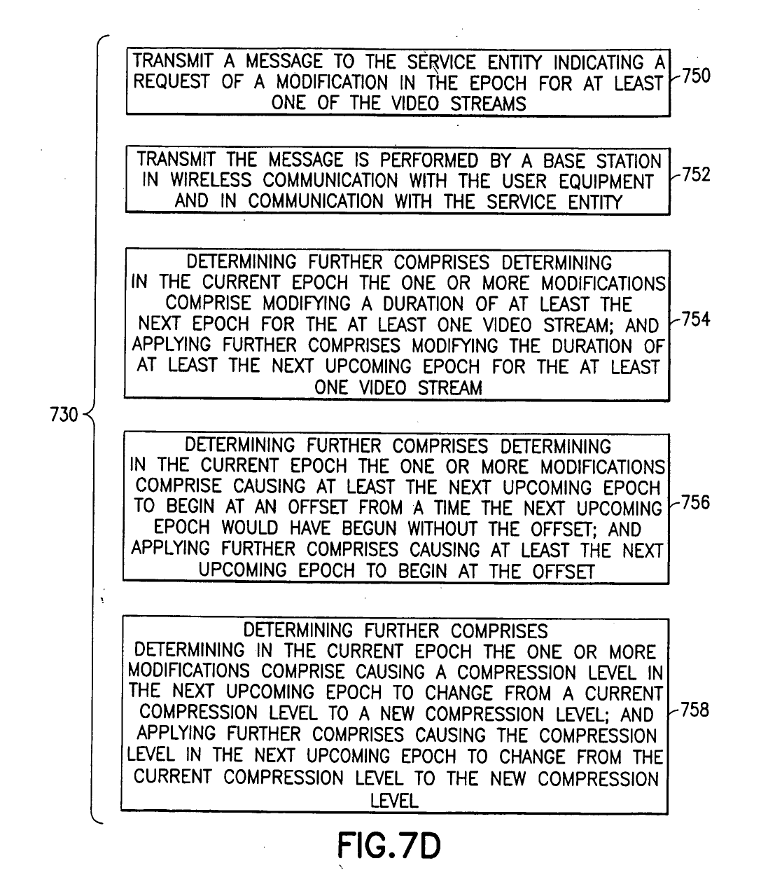

Turning to FIG. 7, this figure includes portions 7A through 7D and shows a flowchart of an exemplary method for video epoch coordination and modification. The method may be performed by a number of elements in the wireless network 100. For instance, one or more the eNB 120, the RAN 115, an SGW 140, and the like may perform the method. In block 710, a temporal loading imbalance is detected in system loading. The imbalance occurs at least at a wireless infrastructure network element in the wireless network 100. The detecting may be performed by, e.g., a base station (e.g., eNB 120, BTS 123), a video server (e.g., video server 165 or content source 175), or a media optimizer 180.

In block 715, responsive to the detection in block 710, one or both of blocks 720 is or are performed. In block 720, a message is transmitted to a service entity indicating the temporal loading imbalance. The service entity serves one or more video streams to one or more user equipment 110 connected to the wireless network 100. The service entity is at least one of a media optimizer, a server that caches one or more of the video streams, an origin video server of the one or more video streams, or a content delivery network element. Block 720, an exemplary embodiment, allows a service entity to take action regarding the temporal loading imbalance, such as modifying epoch duration, modify a subsequent epoch start time for one or more epochs, or performing any of the operations described above.

In block 725, one or more modifications are made. The modifications are associated with at least one of the one or more video streams by determining in a current epoch the one or more modifications to apply in one or more upcoming epochs for the at least one video stream. In response to the one or more upcoming epochs becoming current epochs, applying the one or more modifications. That is, in a current epoch, an entity such as an eNB can determine that an epoch duration should be modified in one or more upcoming epochs, a subsequent epoch start time for one or more upcoming epochs should be modified, and the like, as previously described. Each of these modifications can apply to a video stream or multiple video streams. As the upcoming epochs become current epochs, the entity will then apply the modifications (determined in what will then be a previous epoch).

FIG. 7 also shows examples of these blocks. For instance, block 710 has examples in portion 7B of FIG. 7; block 720 has examples in portion 7C of FIG. 7; and block 725 has examples in portion 7B of FIG. 7. Referring to portion 7B of FIG. 7, in block 726, the System loading is for specific portion of the wireless network. Furthermore (see block 727), the specific portion of the network may be from the video server to a plurality of individual sectors serving the one or more video streams to the user equipment. In this example, detecting further comprises detecting an imbalance between overall loading generated by the application server as compared to a portion of loading that is going to each individual sector. Additionally (see block 728), detecting may include detecting the loading pattern in a particular sector/region, e.g., on multiple paths (e.g., carriers or RF technologies). The imbalance (block 732) may be aperiodic (see FIG. 6) or periodic. If the imbalance is periodic, the interval (e.g., period) of the imbalance may be approximately equal to a value of an epoch. For instance, if one of the epochs is 10 seconds, and the interval of imbalance is approximately 10 seconds, then the alignment of the epochs for multiple video streams may be to blame for the imbalance.

In block 732, the periodic imbalance is determined at two (or more) different times for one or both of: an aggregate loading arriving at the wireless infrastructure network element; or a compression level of one or more video streams from a service entity as compared to wireless assigned modulation and resource blocks throughput.

Referring to portion 7C of FIG. 7, transmitting a message may include (block 740) transmitting a periodic imbalance report indicating: a periodic time interval between increases in system loading, and an absolute timing reference indicating when one peak of the increases occurred. In block 742, transmitting a message may include transmitting the message to the service entity, responsive to a query from that service entity for a periodic imbalance report. Transmitting a message may include (block 744) transmitting the message to at least one of: an origin video server; a media optimizer; a content aware network enabling gateway; or a user equipment. These entities may be able to modify (or cause to be modified) epoch duration, starting time of epochs, time for sending or requesting video, and the like as described above.

Referring to portion 7D of FIG. 7, in block 750, making one or more modifications (in block 725) further may include transmitting a message to the service entity indicating a request of a modification in the epoch for at least one of the video streams. In block 752, the making on or more modification may include a base station performing the transmitting, the base station in wireless communication with the user equipment and in communication with the service entity.

In block 754, determining from block 725 further comprises determining in the current epoch the one or more modifications comprise modifying a duration of at least the next epoch for the at least one video stream. Applying from block 725 further comprises modifying the duration of at least the next upcoming epoch for the at least one video stream.

In block 756, determining from block 725 further comprises determining in the current epoch the one or more modifications comprise causing at least the next upcoming epoch to begin at an offset from a time the next upcoming epoch would have begun without the offset. Applying from block 725 further comprises causing at least the next upcoming epoch to begin at the offset.

In block 756, determining from block 725 further comprises determining in the current epoch the one or more modifications comprise causing a compression level in the next upcoming epoch to change from a current compression level to a new compression level. Applying from block 725 further comprises causing the compression level in the next upcoming epoch to change from the current compression level to the new compression level.

The blocks in portions (e.g., FIGS. 7A to 7D of FIG. 7 merely highlight some of the examples presented above. The highlighted examples are not meant to be exhaustive or limiting.

The exemplary embodiments are applicable to (as non-limiting examples): multiple video protocols (HTTP-Progressive Download, HTTP-Adaptive streaming such as ALS and MSS); macro, pico and AWT architectures; and existing prototype efforts/collaborations.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 3. A computer-readable medium may comprise a computer-readable storage medium (e.g., memory 325 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
detecting a temporal loading imbalance in system loading, the imbalance occurring at least at a wireless infrastructure network element in a wireless network;
in response to the detecting, performing one or both of the following:
transmitting a message to a service entity indicating the temporal loading imbalance, the service entity serving one or more video streams to one or more user equipment connected to the wireless network; or
making one or more modifications associated with at least one of the one or more video streams by determining in a current epoch the one or more modifications to apply in one or more upcoming epochs for the at least one video stream, and, in response to the one or more upcoming epochs becoming current epochs, applying the one or more modifications.

2. The method of claim 1, wherein the one or more video streams are carried over the wireless network using hypertext markup language, and wherein the video is requested by user equipment through a series of separate uniform resource locators, each uniform resource locator corresponding to a different video stream of the one or more video streams.

3. The method of claim 1, performing the detecting in at least one of the following: a base station, a video server, or a media optimizer.

4. The method of claim 3, wherein the system loading considered is loading for a specific portion of the wireless network.

5. The method of claim 4, wherein the specific portion comprises a portion of the network from the video server to a plurality of individual sectors serving the one or more video streams to the user equipment, and wherein detecting the imbalance further comprises detecting an imbalance between overall loading generated by the application server as compared to a portion of loading that is going to each individual sector.

6. The method of claim 1, wherein the temporal loading imbalance is an aperiodic loading imbalance.

7. The method of claim 1, wherein the temporal loading imbalance is a periodic loading imbalance.

8. The method of claim 7, wherein the periodic loading imbalance in the system loading at the wireless infrastructure network element comprises a periodic imbalance at two different times in at least one of:
an aggregate loading arriving at the wireless infrastructure network element; or
a compression level of one or more video streams from a service entity as compared to wireless assigned modulation and resource blocks throughput.

9. The method of claim 7, wherein a period of the periodic imbalance has an interval approximately equal to a value of an epoch for at least one of the one or more video streams.

10. The method of claim 1, wherein making the one or more modifications further comprises transmitting a message to the service entity indicating a request of a modification in the epoch for at least one of the video streams.

11. The method of claim 10, wherein transmitting the message is performed by a base station in wireless communication with the user equipment and in communication with the service entity.

12. The method of claim 1, wherein the transmitting the message to the service entity comprises transmitting a message comprising a periodic imbalance report indicating:
a periodic time interval between increases in system loading, and an absolute timing reference indicating when one peak of the increases occurred.

13. The method of claim 12, wherein the transmitting the message to the service entity is performed responsive to a query from that service entity for a periodic imbalance report.

14. The method of claim 1, wherein the transmitting the message to the service entity indicating the periodic imbalance timing structure further comprises transmitting the message to at least one of:
an origin video server;
a media optimizer;
a content aware network enabling gateway; or
a user equipment.

15. The method of claim 1, wherein the service entity comprises at least one of a media optimizer, a server that caches one or more of the video streams, an origin video server of the one or more video streams, or a content delivery network element.

16. The method of claim 1, wherein:
determining further comprises determining in the current epoch the one or more modifications comprise modifying a duration of at least the next epoch for the at least one video stream; and
applying further comprises modifying the duration of at least the next upcoming epoch for the at least one video stream.

17. The method of claim 1, wherein:
determining further comprises determining in the current epoch the one or more modifications comprise causing at least the next upcoming epoch to begin at an offset from a time the next upcoming epoch would have begun without the offset; and
applying further comprises causing at least the next upcoming epoch to begin at the offset.

18. The method of claim 1, wherein:
determining further comprises determining in the current epoch the one or more modifications comprise causing a compression level in the next upcoming epoch to change from a current compression level to a new compression level; and
applying further comprises causing the compression level in the next upcoming epoch to change from the current compression level to the new compression level.

19. An apparatus, comprising:
one or more processors; and
one or more memories including computer program code,
the one or more memories and the computer program code configured to, with the one or more processors, cause the apparatus to perform at least the following:
detecting a temporal loading imbalance in system loading, the imbalance occurring at least at a wireless infrastructure network element in a wireless network;
in response to the detecting, performing one or both of the following:
transmitting a message to a service entity indicating the temporal loading imbalance, the service entity serving one or more video streams to one or more user equipment connected to the wireless network; or
making one or more modifications associated with at least one of the one or more video streams by determining in a current epoch the one or more modifications to apply in one or more upcoming epochs for the at least one video stream, and, in response to the one or more upcoming epochs becoming current epochs, applying the one or more modifications.

20. (canceled)

21. A computer program product comprising a computer-readable medium bearing computer program code embodied therein for use with a computer, the computer program code comprising:
code for detecting a temporal loading imbalance in system loading, the imbalance occurring at least at a wireless infrastructure network element in a wireless network;
code, in response to the detecting, for performing one or both of the following:
transmitting a message to a service entity indicating the temporal loading imbalance, the service entity serving one or more video streams to one or more user equipment connected to the wireless network; or
making one or more modifications associated with at least one of the one or more video streams by determining in a current epoch the one or more modifications to apply in one or more upcoming epochs for the at least one video stream, and, in response to the one or more upcoming epochs becoming current epochs, applying the one or more modifications.

22. (canceled)

23. (canceled)

24. (canceled)
